(19) United States
(12) Patent Application Publication
(10) Pub. No.: US 2007/0094798 A1
(43) Pub. Date: May 3, 2007

(54) Platform assembly for an operating bed

(76) Inventor: Chun Ho Yu, Hong Kong (HK)

Correspondence Address: THE MAXHAM FIRM, 9330 SCRANTON ROAD, SUITE 350, SAN DIEGO, CA, 92121, US

(21) Appl. No.: 11/261,847

(22) Filed: Oct. 28, 2005

(51) Int. Cl. A61G 13/10

(52) U.S. Cl. 5/621; 5/512; 5/600; 5/507.1

(57) ABSTRACT

A platform assembly for an operating bed includes a platform structured to cover a portion of the operating bed, and a plurality of side leg members that are height adjustable. Each of the side leg members are vertically collapsible, and have an upper end attached to the platform and a lower end for securing to the operating bed. The platform assembly further includes one or more central leg members which are also height adjustable. Each of the central leg members has an upper end attached to the platform and a lower end for contacting the operating bed.

### BACKGROUND OF THE INVENTION

1. Field of the Invention

The present invention relates generally to a surgical apparatus that facilitates image guided diagnostic and therapeutic medical operative procedures. The surgical apparatus includes a convenient working platform that may be attached to an operating bed and supports surgical instruments, such as a catheter and guide wire.

2. Discussion of the Related Art

The present invention may be used in image guided diagnostic and therapeutic medical operative procedures, which are often performed in a delicate manner with specialized instruments such as a catheter and guide wire. Examples of such procedures are vascular and interventional radiological procedures for endovascular treatment of cancers and cerebrovascular diseases, and angioplasty and stenting procedures for diseased vessels such as heart vessels. During such procedures, the operator, who may be a physician, surgeon, or other individual, inserts instruments such as the catheter and guide wire into the patient's body to reach the target organ. The operator may remotely control the instruments outside the patient's body to operate on the target organ. The operator often monitors the operation through a monitor displaying the situation of the surgical area inside the patient's body.

The performance of the operation requires accurate tracking and precise positioning of the catheter and guide wire at the target location through fine manipulation of the instruments outside the patient's body. Such manipulation is currently performed by the operator with hands holding the instruments and resting on the patient's body.

Currently, the operator holds the catheter while resting their hand on the patient's body during fixation of the instruments, and simultaneously using their other hand to advance, withdraw, and/or rotate the catheter, and/or guide wire, or other instruments. Such manipulation requires a high degree of skill and dexterity to hold and control the catheter and guide wire steadily at the same time.

In current practice the operator's hands tire quickly, which makes it more difficult for the operator to control the instruments precisely. Though the hands of the operator may rest on the patient's body, the body surface is irregular and curved and the body moves from time to time due to pain suffered by the patient during the operation. As precise manipulation of the catheter and guide wire is of utmost importance, especially when the operation is conducted on blood vessels in the brain, for example, operators are looking for a stable platform which can support their arms and hands.

Moreover, instruments with sharp points and edges which are placed on the patient's body may accidentally injure the patient. The patient's body may also be exposed to fluids used for continuous irrigation of the instruments during the operation. Operators are looking for a device which overcomes the foregoing shortcomings and which provides, for example, a large shield to cover and protect the patient's body.

A catheter and guide wire are typically long and occupy considerable space. In current practice, the catheter and guide wire are placed on the patient's body for easy access and convenient handling. The body is irregular and curved. The catheter and guide wire are significantly longer than the operating bed. As such, the catheter, guide wire, and other instruments cannot always be arranged in an orderly manner on the patient's body.

During the operation, an assistant is typically required to hold the catheter and guide wire at the end of the operating bed to avoid the catheter and guide wire from slipping off the patient's body and the operation table. If the catheter and guide wire slips off, it may pull the catheter and guide wire out of the operating area of the patient's body and thus cause serious injury to the patient. Existing platforms, such as that disclosed in international publication WO 99/23965, cannot provide a flat and large platform for placing the instruments and apparatus in an orderly manner and prevent the catheter and guide wire from slipping off. Accordingly, there is a further need for a system that will also free the assistant from holding the catheter and guide wire so that they can be assigned to perform other duties.

### SUMMARY OF THE INVENTION

An embodiment of the present invention provides a platform assembly for an operating bed which comprises a flat and broad surface. This surface supports instruments and apparatus, such as the catheter and guide wire, for image guided diagnostic and therapeutic medical operative procedures. The flat and broad surface allows a long catheter and associated guide wire to be orderly and safely arranged, prevented from accidental slipping, and permits these devices to be delivered to the target location inside the patient's body steadily, safely, and precisely. The operator is therefore free to use both hands for the manipulation of the catheter and guide wire. The present invention will improve the way the operator manipulates the catheter and guide wire in performing the operation, and simplifies the operative procedure. With the assistance of the present invention, greater numbers of operators will be able to master the techniques necessary for manipulation of the catheter and guide wire in performing operations.

Another embodiment of the present invention provides a platform assembly for an operating bed that allows the operator to perform the operation precisely and continuously for extended periods without undue strain in their arms and hands. This improves operator efficiency, performance, as well as the ultimate results of the operation.

Yet another embodiment of the present invention provides a platform assembly for an operating bed which can be easily installed onto or removed from an operating bed.

Still yet another embodiment of the present invention provides a platform assembly for an operating bed with a platform surface which can easily open for accommodating the patient.

One embodiment of the present invention provides a platform assembly for an operating bed which shields the body of the patient and protects it from sharp points and edges of operating instruments and other devices.

Another embodiment of the present invention provides a platform assembly for an operating bed which reduces or prevents the patient's body from contacting fluids used for continuous irrigation of the instruments.

Yet another embodiment of the present invention provides a platform assembly for an operating bed with leg members that are adjustable in height, thereby adaptable with variously sized patients

Still yet another embodiment of the present invention provides a platform assembly for an operating bed which maintains the patient's body in a fixed position, thus preventing or minimizing movement of the patient's body which could potentially disturb the operation. This aspect additionally reduces the risks of damage to the patient caused by the accidental movement of the patient which may occur during the operation.

An embodiment of the present invention provides a platform assembly for an operating bed which can be extended to increase the platform surface for manipulation of the catheter and guide wire, and for arranging other apparatuses and instruments. Examples of such instruments include balloon catheters, implantation devices such as stents and embolization coils, cables for electric detachment of implantation devices, infusion connectors and tubings, injection syringes, and injectable agents, among others.

Another embodiment of the present invention includes a platform assembly for an operating bed which provides a convenient device for supporting a sterile table drape which covers a large portion of the patient's body and provides a sterile surgical operating environment therein.

Yet another embodiment of the present invention includes a platform assembly for an operating bed which provides a plurality of flaps at the end of the platform surface to form a slope that prevents an abrupt fall of the catheter and guide wire from the end of the platform.

An embodiment of the present invention includes a platform assembly for an operating bed which provides a hang rail attached to the side of the platform for hanging or attaching surgical instruments such as bottles of medical fluid and drugs to be infused along drip lines into the patient, and electric batteries for electric detachment of implantable devices.

Another embodiment of the present invention includes a platform assembly for an operating bed which provides a cutout section disposed at the side of the platform for receiving surgical instruments such as a motorized contrast injector and injection pumps for injection of medical fluid and drugs. The cutout section permits attachment of such devices to the rail of the operating bed.

An embodiment of the present invention includes a platform assembly for an operating bed which provides a slightly raised vertical edge on its side to prevent equipment and apparatus from falling off the platform.

### BRIEF DESCRIPTION OF THE DRAWING

The above and other aspects, features, and advantages of the present invention will become more apparent upon consideration of the following description of preferred embodiments, taken in conjunction with the accompanying drawing figures, wherein:

FIG. 1 is a perspective view of a conventional operating bed configured with a platform assembly according to an embodiment of the present invention installed;

FIG. 2 is a top plan view of the operating bed and platform assembly of FIG. 1;

FIG. 3 is a perspective view of the operating bed and platform assembly of FIG. 1 during an operation;

FIG. 4 illustrates one of the height adjusting leg members of the platform assembly of FIG. 1;

FIG. 5 illustrates the platform assembly of FIG. 1 in the open position to accommodate a patient;

FIGS. 6a-6c illustrate the hinge joint and springs connecting the leg body and platform assembly;

FIGS. 7a and 7b illustrate flaps of the platform resting on a patient; and

FIG. 8 illustrates the hang rail attached to the platform assembly.

### DETAILED DESCRIPTION OF PREFERRED EMBODIMENTS

In the following detailed description, reference is made to the accompanying drawing figures which form a part hereof, and which show by way of illustration specific embodiments of the invention. It is to be understood by those of ordinary skill in this technological field that other embodiments may be utilized, and structural, as well as procedural, changes may be made without departing from the scope of the present invention.

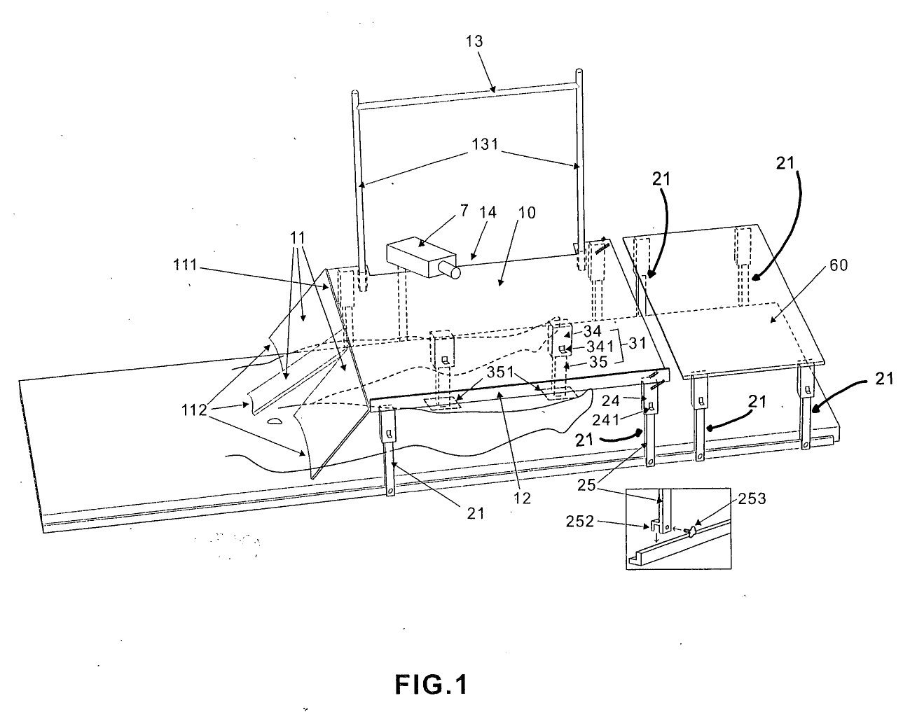

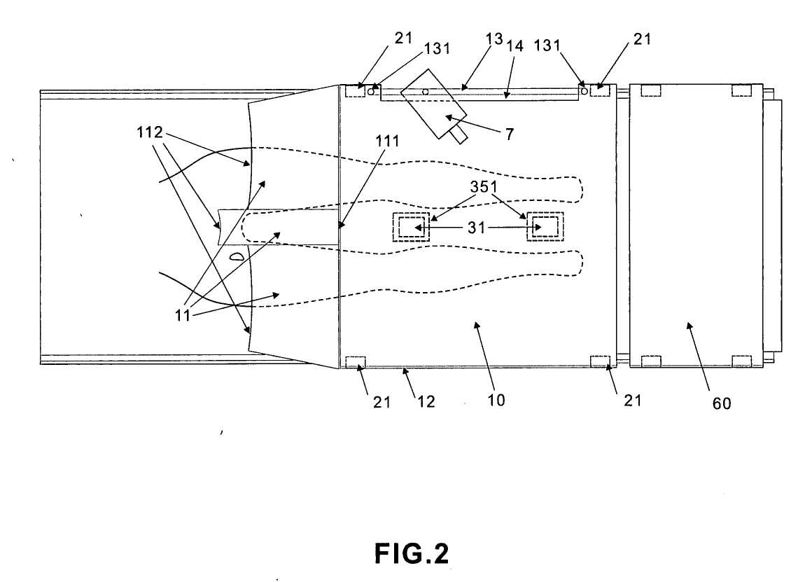

As illustrated in FIGS. 1 and 2, an embodiment of the present invention includes a stable, broad, and substantially flat platform 10 for supporting lengthy instruments and apparatuses, such as a catheter and guide wire. The platform further includes four side leg members 21 for supporting the platform and fixing the platform on the rail of the operating bed, and two central leg members 31 for supporting the center of the platform. For clarity, further description of the present invention will be provided with reference to the term “instruments,” but such teachings apply equally to others devices and apparatus as disclosed herein.

In an embodiment, platform 10 may be implemented as a broad and substantially flat surface with a length of about 200 cm and a width of about 60 cm. As shown in FIG. 1, the platform may be placed over the operating bed, effectively covering the width of the bed, and extending over a length-wise portion of the operating bed. The platform may be arranged so that it is proximate to the sites of the surgical procedure on the patient (for example, legs, torso, or head). This is typically accomplished by arranging the platform at or near the center of the operating bed. Such arrangement allows the operator to arrange the instruments on the platform in an orderly manner, and permits manipulating of the instruments during the operation.

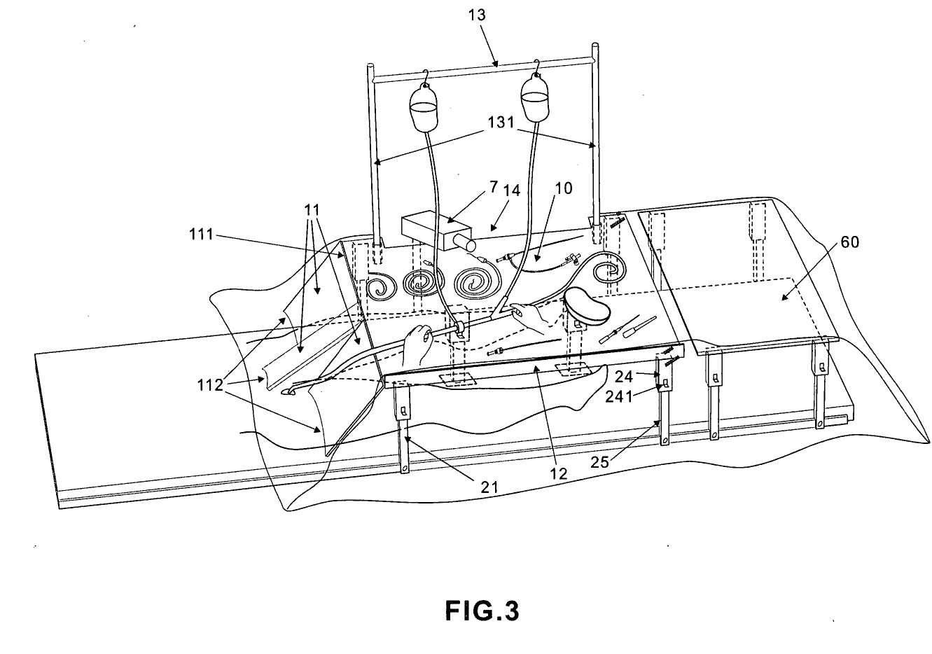

As illustrated in FIG. 3, a sterile table drape may be placed over platform 10 to provide a sterile surgical operating environment between the platform and the operating table. Catheters and guide wires are shown being manipulated on the platform. Other instruments, such as balloon catheters, stents, embolization coils, injection syringes, injectable agents, and standby catheters, are shown orderly arranged on platform 10 and are positioned for use.

Since platform 10 is a broad surface, four side leg members 21 are located under two sides of the platform, and two central leg members 31 are located under a central area of the platform. Optional central leg members 31 are typically used to minimize or prevent the middle part of the platform from bending downward due to the weight of the platform and associated instruments.

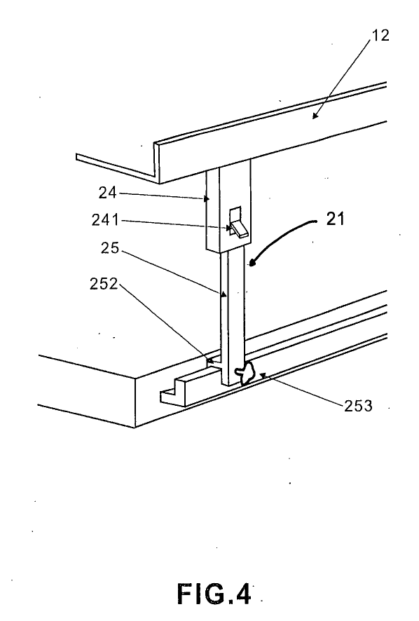

As illustrated in FIG. 4, side leg members 21 may be structured as adjustable leg members, thus permitting the adjustment of the height of platform 10 relative to the operating bed and patient. By way of non-limiting example, the height of the side leg members may be adjusted so that the platform can be positioned between 5-12 inches above the operating bed to fit different patient sizes. Such adjustments may be performed before the patient is positioned on the operating bed, or during the surgical procedure while the patient is on the bed.

Each side leg member 21 further includes a telescopic outer upper side leg body 24 which slideably receives a telescopic inner lower side leg body 25. The upper side leg body is shown secured by locking button 241 which locks into one of the corresponding slots (not shown) of different locations on lower side leg body 25. The bottom portion of lower side leg body 25 is shown formed with a rectangular slit 252, which engages with the rail located along the side of the operating bed. The lower side leg body may be secured to the rail by a suitable fastener, such as setscrew 253.

Each central leg member 31 may be formed using components similar to that used to form side leg members 21. For instance, as shown in FIG. 1, each central leg member 31 may include a telescopic outer upper central leg body 34 which slideably receives a telescopic inner lower central leg body 35. Upper central leg body 34 may be secured by locking button 341, which locks into one of the corresponding slots (not shown) of different locations on lower central leg body 35. FIG. 1 also shows flat plate 351 mounted to the bottom portion of lower central leg body 35. The height of leg member 31 is typically adjusted so that flat plate 351 contacts the top surface of the operating bed.

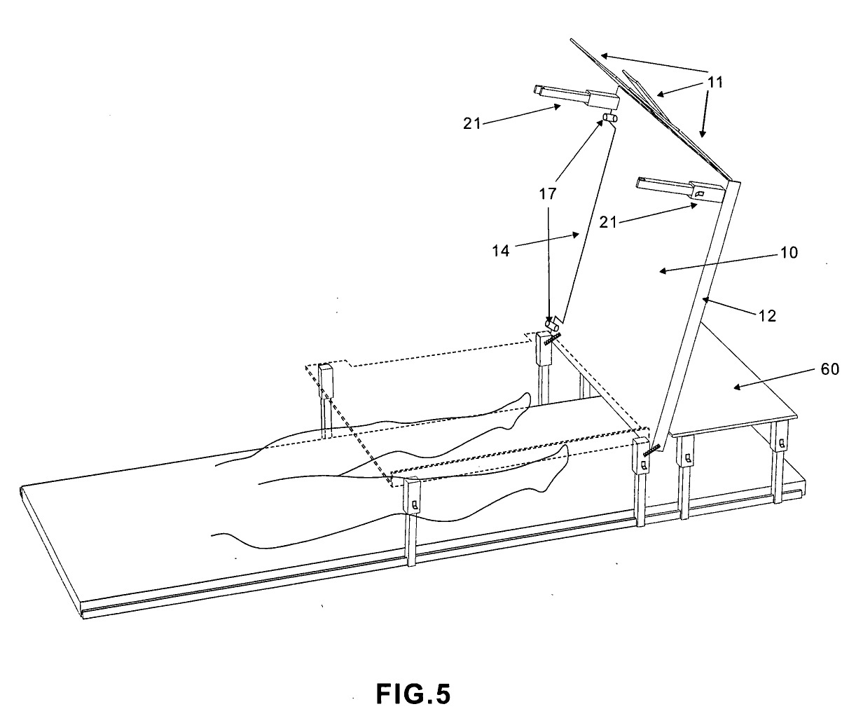

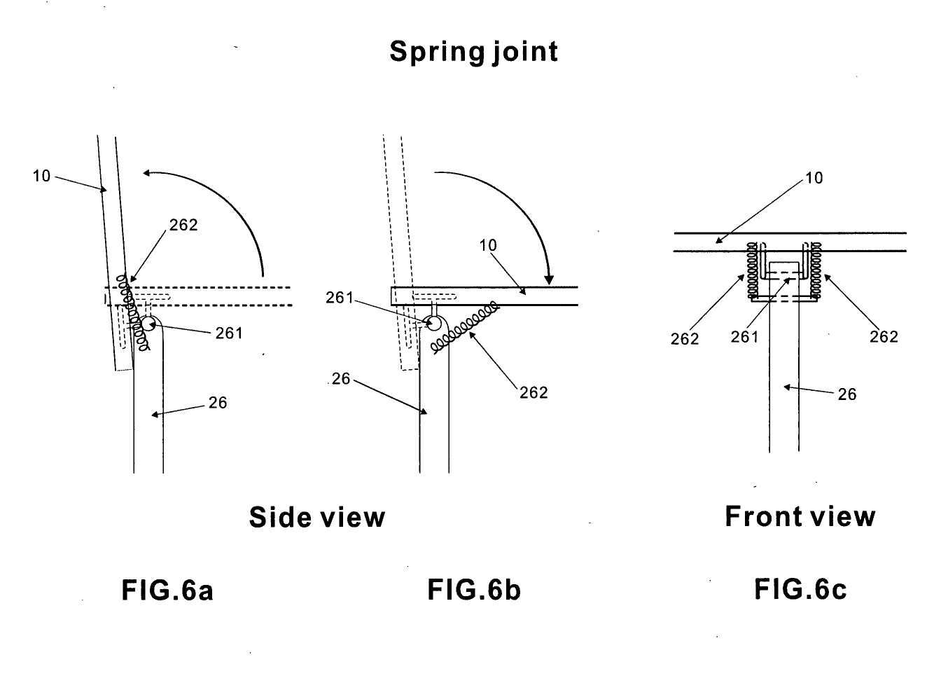

As illustrated in FIG. 5, platform 10 may be constructed to allow opening of the platform. This feature is useful when positioning or removing the patient from the operating bed, or when observation or manipulation of the patient is desired during the operation. As illustrated in FIGS. 6a, 6b and 6c, platform 10 is pivotally connected to each upper leg body 26 at the pivot end by hinge joint 261. Two springs 262 are shown connecting upper leg body 26 and the bottom of platform 10. The springs are helpful in restricting the pivot rotation of the platform to a desired degree of rotation (for example, slightly more than 90 degrees).

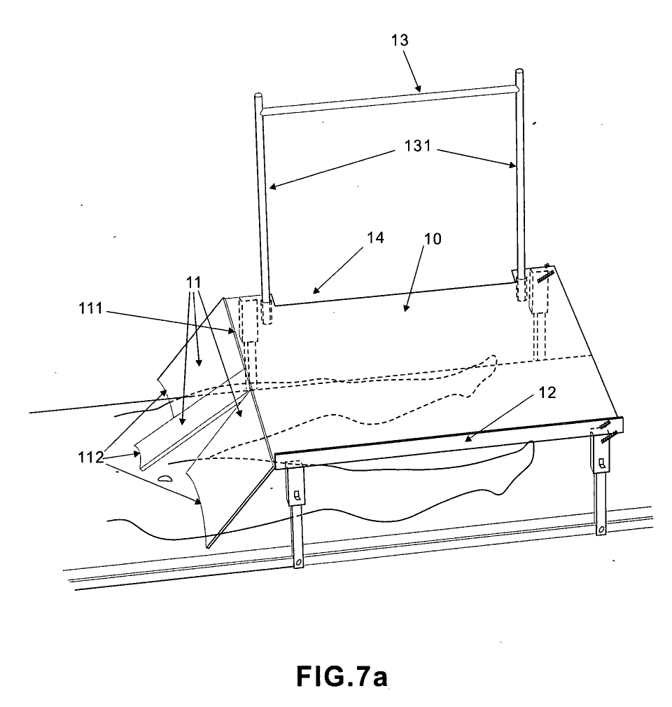

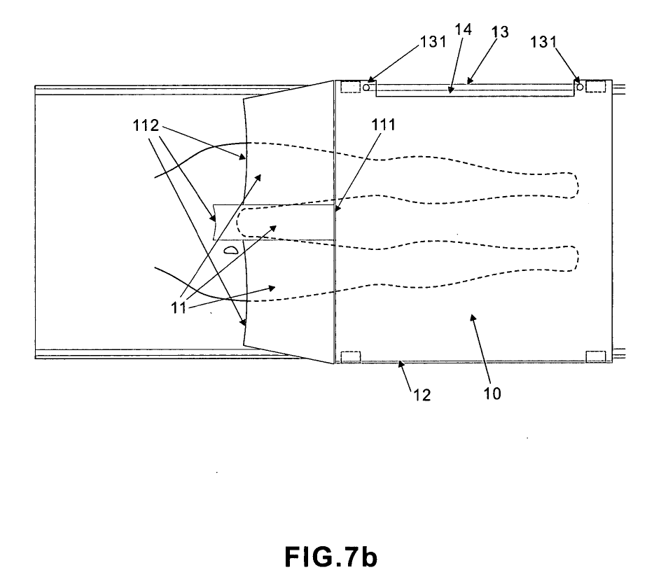

As illustrated in FIGS. 7a and 7b, platform 10 is shown having optional flaps 11, each of which is pivotally connected to the edge of the platform, at hinge joint 111, proximate to the head-end of operating bed. When the platform is in the closed position, thus covering a portion of the patient, flaps 11 may be flipped down so that they contact the patient's thighs. If desired, middle flap 11 may be formed so that it is slightly longer than the other flaps. This longer flap is useful for covering portions of the patient's abdomen. The flaps may optionally be formed with concave curve 112 to facilitate contact with the curvature of body parts. Optimally, the flaps are structured so that they form a downward slope between the edge of the platform and the patient, which is helpful in preventing an abrupt drop of the catheter and guide wire from the edge of the platform onto the patient.

Platform 10 is also shown having a slightly raised vertical edge 12 of about 2 cm in height. This vertical edge is often located on the platform on the side from which the operator is positioned during the procedure, and is helpful in preventing instruments from falling off the platform.

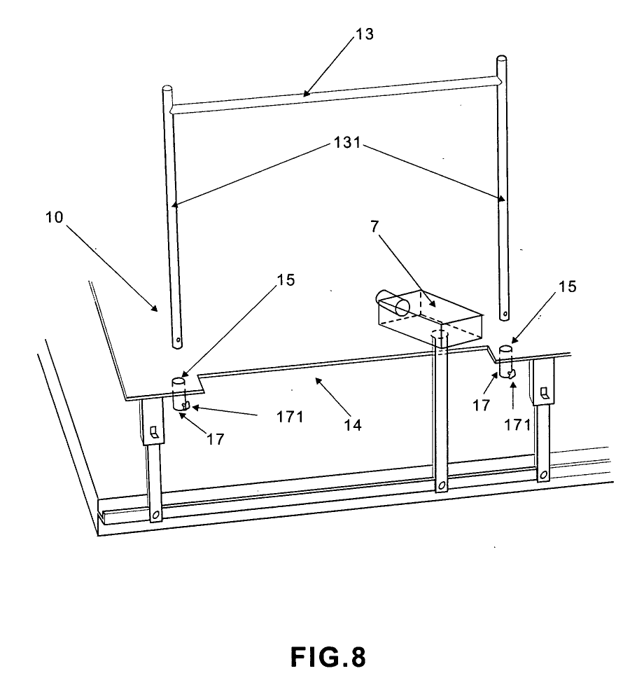

The platform is configured with optional hang rail 13, which may be welded to hang rail legs 131. The hang rail is typically located on the opposite side of the platform from which the operator is positioned during the procedure. As illustrated in FIG. 8, hang rail leg 131 is received by hole 15, which is formed in platform 10. A cylindrical tubular portion 17, with a sealed bottom, extends from the bottom of the platform around the hole 15. Tubular portion 17 may be used for supporting and securing hang rail leg 131. The hang rail leg may be secured to the tubular portion by a suitable fastener, such as setscrew 171.

Hang rail 13 is typically used for hanging various instruments such as bottles of medical fluid and drugs to be infused along drip lines into the patient, electric batteries for electric detachment of implantable devices during the operation, and the like. The hang rail may be positioned slightly lower than the top portion of hang rail leg 131. This configuration forms a stop to prevent the instruments that are hung from the hang rail from falling off the end of the hang rail.

Since the width of the platform may be structured so that it is wider than the width of the operating bed, a cutout section 14 may be formed on one side of the platform. The cutout section 14 is useful whenever use of equipment, such as motorized contrast injector 7 and injection pumps for injection of medical fluid and drugs, is desired during the operation. For example, such equipment may be attached to the rail of the operating bed so that this equipment can be placed as close to the patient as possible. The cutout section thus allows this equipment to attach to the rail of the operating bed without being impeded by the platform. By way of example, the cutout section may have a length of about 70 cm, and a width of about 5 cm.

As an addition or as an alternative to platform 10, a relatively smaller platform may be implemented. For example, as illustrated in FIG. 1, platform 60 is shown positioned relative to platform 10 and serves as an extension to platform 10. Platform 60 is a relatively smaller platform and includes four leg members, which are similar to leg members 21, which are attached to the operating bed.

Some or all of the above-described components, including platform 60, platform 10, side leg members 21, central leg members 31, flaps 11, and vertical edge 12, may be formed from X-ray transmittable materials so that these components are compatible with X-ray equipment. Additionally or alternatively, such components may be formed from a transparent material, such as Perspex Acrylic, plastic, or silicon, to enable the operator to view the patient during the operation.

While the invention has been described in detail with reference to disclosed embodiments, various modifications within the scope of the invention will be apparent to those of ordinary skill in this technological field. It is to be appreciated that features described with respect to one embodiment typically may be applied to other embodiments. Therefore, the invention properly is to be construed only with reference to the claims.

What is claimed is:

1. A platform assembly for an operating bed, comprising:
a platform structured to cover a portion of said operating bed;
a plurality of side leg members structured to be height adjustable, each of said side leg members being vertically collapsible and having an upper end attached to said platform and a lower end being configured to be secured to said operating bed; and
at least one central leg member structured to be height adjustable, said at least one central leg member being vertically collapsible and having an upper end attached to said platform and a lower end being configured to contact said operating bed.

2. The platform assembly according to claim 1, further comprising:
a plurality of central leg members, each having an upper end attached to said platform and a lower end configured to contact said operating bed.

3. The platform assembly according to claim 2, wherein each central leg member of said plurality of central leg members comprises a flat plate for contacting said operating bed.

4. The platform assembly according to claim 1, wherein each side leg member of said plurality of side leg members further comprises:
an upper telescopic outer leg body which slideably receives a lower telescopic inner leg body; and
a locking structure for selectably fixing an axial displacement of said upper telescopic outer leg body with respect to said lower telescopic inner leg body.

5. The platform assembly according to claim 2, wherein each central leg member of said plurality of central leg members further comprises:
an upper telescopic outer leg body which slideably receives a lower telescopic inner leg body; and
a locking structure for selectably fixing an axial displacement of said upper telescopic outer leg body with respect to said lower telescopic inner leg body.

6. The platform assembly according to claim 5, further comprising:
at least one flap coupled to said platform.

7. The platform assembly according to claim 5, further comprising:
a hinge joint which couples one side of said platform to two side leg members of said plurality of side leg members.

8. The platform assembly according to claim 1, wherein said lower end of each side leg member of said plurality of side leg members is adapted for securing to a rail associated with said operating bed.

9. The platform assembly according to claim 1, wherein said platform is substantially flat.

10. The platform assembly according to claim 1, further comprising:
at least one flap coupled to said platform.

11. The platform assembly according to claim 1, further comprising:
a plurality of flaps coupled to said platform.

12. The platform assembly according to claim 1, further comprising:
a plurality of flaps pivotally connected to one side of said platform.

13. The platform assembly according to claim 1, further comprising:
a hinge joint which couples one side of said platform to two side leg members of said plurality of side leg members.

14. The platform assembly according to claim 13, further comprising:
a plurality of springs facilitating said coupling of said platform to said two side leg members of said plurality of side leg members.

15. The platform assembly according to claim 1, further comprising:
apertures formed in said platform; and
a hanging assembly comprising a horizontal bar which extends between two vertically extending posts, each of said two vertically extending posts being sized to be received within said apertures.

16. The platform assembly according to claim 15, further comprising:
tubular portions extending from a bottom side of said platform and adjacent to an associated one of said apertures, wherein each of said tubular portions are sized to receive an end portion of one of said two vertically extending posts.

17. The platform assembly according to claim 15, wherein said horizontal bar is attached to said two vertically extending posts at a distance from exposed ends of said two vertically extending posts.

18. The platform assembly according to claim 1, further comprising:
a vertical edge which extends from said platform.

19. The platform assembly according to claim 1, further comprising:
a cutout section formed in a side of said platform.

20. The platform assembly according to claim 1, further comprising:
an extension platform which cooperates with said platform assembly, said extension platform being structured to cover a portion of said operating bed, said extension platform comprising:
a plurality of side leg members, each having an upper end attached to said extension platform and a lower end configured to be secured to said operating bed.

21. The platform assembly according to claim 1, wherein said platform, said plurality of side leg members, and said at least one central leg member comprise X-ray transmittable material.

22. The platform assembly according to claim 1, wherein said platform, said plurality of side leg members, and said at least one central leg member comprise optically transparent material.

23. The platform assembly according to claim 1, wherein said platform, said plurality of side leg members, and said at least one central leg member are formed from a material selected from the group consisting of acrylic, plastic, and silicon.

24. A platform assembly for an operating bed, comprising:
a substantially flat platform structured to cover a portion of said operating bed;
a plurality of side leg members structured to be height adjustable, each of said side leg members being vertically collapsible and having an upper end attached to said platform and a lower end configured to be secured to said operating bed;
at least one central leg member structured to be height adjustable, said at least one central leg member being vertically collapsible and having an upper end attached to said platform and a lower end configured to contact said operating bed;
a hinge joint which couples one side of said platform to two side leg members of said plurality of side leg members; and
a plurality of springs facilitating said coupling of said platform to said two side leg members.

25. The platform assembly according to claim 24, further comprising:
a cutout section formed in a side of said platform.
